(19) United States
(12) Patent Application Publication
(10) Pub. No.: US 2013/0035273 A1
(43) Pub. Date: Feb. 7, 2013

(54) COMPOSITION CONTAINING A POLYSACCHARIDE HYBRID POLYMER AND METHODS OF CONTROLLING HARD WATER SCALE

(71) Applicants: Carter Silvernail, Burnsville, MN (US); Erik C. Olson, Eagan, MN (US)

(72) Inventors: Carter Silvernail, Burnsville, MN (US); Erik C. Olson, Eagan, MN (US)

(73) Assignee: ECOLAB USA INC., St. Paul, MN (US)

(21) Appl. No.: 13/204,368

(22) Filed: Aug. 5, 2011

(51) Int. Cl. C11D 3/60; C11D 3/37

(52) U.S. Cl. 510/467; 510/471

(57) ABSTRACT

A composition includes a polysaccharide hybrid polymer and 2-phosphonobutane-1,2,4-tricarboxylic acid. In one embodiment, the polysaccharide hybrid polymer includes a polysaccharide residue present in an amount between approximately 30% to 80% by weight of the polysaccharide hybrid polymer and a residue of acrylic acid, methacrylic acid or a combination thereof present in an amount between approximately 5% to 75% by weight of the polysaccharide hybrid polymer.

### TECHNICAL FIELD

The present invention is related to the field of hard water scale control. In particular, the present invention is related to a composition including a polysaccharide hybrid polymer and 2-phosphonobutane-1,2,4-tricarboxylic acid or salts thereof for hard water scale control, particularly in a high alkaline environment.

### BACKGROUND

Conventional detergents used in food and beverage (e.g., the dairy, cheese, sugar, meat, food, and brewery and other beverage industries), warewashing and laundry industries include alkaline detergents. Alkaline detergents, particularly those intended for institutional and commercial use, generally contain phosphates, nitrilotriacetic acid (NTA) and ethylenediaminetetraacetic acid (EDTA). Phosphates, NTA and EDTA are components commonly used in detergents to remove soils and to sequester metal ions such as calcium, magnesium and iron.

In particular, NTA, EDTA or polyphosphates such as sodium tripolyphosphate and their salts are used in detergents because of their ability to solubilize preexisting inorganic salts and/or soils. When calcium, magnesium and iron salts precipitate, the crystals may attach to the surface being cleaned and cause undesirable effects. For example, calcium carbonate precipitation on the surface of ware can negatively impact the aesthetic appearance of the ware, giving an unclean look. In the laundering area, if calcium carbonate precipitates and attaches onto the surface of fabric, the crystals may leave the fabric feeling hard and rough to the touch. In the food and beverage industry, the calcium carbonate residue can affect the acidity levels of foods. The ability of NTA, EDTA and polyphosphates to remove metal ions facilitates the detergency of the solution by preventing hardness precipitation, assisting in soil removal and/or preventing soil redeposition into the wash solution or wash water.

While effective, phosphates and NTA are subject to government regulations due to environmental and health concerns. Although EDTA is not currently regulated, it is believed that government regulations may be implemented due to environmental persistence. Therefore, there is a need in the art for an alternative, and preferably environment friendly, cleaning composition that can replace the properties of phosphorous-containing compounds such as phosphates, phosphonates, phosphites, and acrylic phosphinate polymers, as well as non-biodegradable aminocarboxylates such as NTA and EDTA.

### SUMMARY

The present invention includes a composition for controlling hard water scale accumulation. The composition includes a polysaccharide hybrid polymer and 2-phosphonobutane-1,2,4-tricarboxylic acid. In one embodiment, the polysaccharide hybrid polymer includes a polysaccharide residue present in an amount between approximately 30% and 80% by weight of the polymer and a residue of acrylic acid, methacrylic acid or combinations thereof present in an amount between approximately 5% and 75% by weight of the polymer. The polymer can optionally include a residue of an ethylenically unsaturated monomer, and the residue of the ethylenically unsaturated monomer can be present in an amount between approximately 5% and 75% by weight of the polymer.

In another embodiment, the composition is used by mixing water with the composition to form a use solution. The water and composition are mixed so that the use solution has a polysaccharide hybrid polymer concentration between about 1 part-per-million (ppm) and 500 ppm.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### DETAILED DESCRIPTION

The present compositions include a polysaccharide hybrid polymer and 2-phosphonobutane-1,2,4-tricarboxylic acid or salts thereof (PBTC). Such compositions may be useful in controlling hard water scale, particularly in water treatment applications and in high alkaline environments. Further, such compositions can be biodegradable and substantially free of phosphorous containing components to comply with various regulatory requirements.

The present compositions can be used in any environment in which it is desirable to control hard water scale and to remove or prevent redeposition of soil, such as protein, on surfaces such as but not limited to plastic, glass, ceramic and metal. Example applications include warewashing, laundering, institutional, health care, food and beverage, and water treatment applications. More particularly, example applications include, but are not limited to: machine and manual warewashing, presoaks, laundry and textile cleaning and destaining, carpet cleaning and destaining, surface cleaning and destaining, kitchen and bath cleaning and destaining, floor cleaning and destaining, cleaning in place operations, general purpose cleaning and destaining, industrial or household cleaners, and industrial or municipal water systems. Methods of using the composition are also provided.

The compositions generally include a polysaccharide hybrid polymer, and 2-phosphonobutane-1,2,4-tricarboxylic acid or salts thereof (PBTC). Suitable weight ratios of polysaccharide hybrid polymer to PBTC are between about 15:1 and about 1:15. Particularly suitable weight ratios of polysaccharide hybrid polymer to PBTC are between about 10:1 and about 1:10.

The polysaccharide hybrid polymer includes residue of a polysaccharide, residue of acrylic acid, methacrylic acid or combinations thereof, and optionally residue of an ethylenically unsaturated monomer. Polymerization may change a component from its original structure to a derivative structure. As used herein, the term “residue” refers to the starting component or anything derived from the component during polymerization which is part of the polymer. For example, a residue of acrylic acid includes acrylic acid and anything derived from acrylic acid during polymerization which is part of the polymer. In one example, the polysaccharide hybrid polymer can have a molecular weight between about 2,000 g/mol and about 25,000 g/mol.

The residue of a polysaccharide includes a polysaccharide and anything derived from the polysaccharide during polymerization which is part of the polysaccharide hybrid polymer. Suitable polysaccharides can be derived from plant, animal and microbial sources. Example polysaccharides include but are not limited to maltodextrins, starches, cellulose, gums (e.g., gum arabic, guar and xanthan), alginates, pectin and gellan. Suitable starches include those derived from maize, potato, tapioca, wheat, rice, pea, sago, oat, barley, rye, and amaranth, including conventional hybrids or genetically engineered materials. Additional example polysaccharides include hemicellulose or plant cell wall polysaccharides such as D-xylans.

The polysaccharides can be modified or derivatized by etherification (e.g., via treatment with propylene oxide, ethylene oxide, 2,3-epoxypropyltrimethylammonium chloride), esterification (e.g., via reaction with acetic anhydride, octenyl succinic anhydride (OSA)), acid hydrolysis, dextrinization, oxidation or enzyme treatment (e.g., starch modified with α-amylase, β-amylase, pullanase, isoamylase or glucoamylase), or various combinations of these treatments.

The polysaccharide hybrid polymer also includes residue of acrylic acid, methacrylic acid or combinations thereof. In one example, the polysaccharide hybrid polymer includes acrylic acid residue. The residue of acrylic and methacrylic acid may be derived from acrylic and methacrylic acid monomers or may be generated from a hydrolyzable monomer. For example, a methacrylic acid residue may be partially or completely hydrolyzed from methyl methacylic acid. The residues of acrylic acid and methacrylic acid may also be present as lithium, sodium, and potassium salts.

The polysaccharide hybrid polymer may optionally include residue of one or more ethylenically unsaturated monomers. Example ethylenically unsaturated monomers include but are not limited to methacrylic acid, ethyacrylic acid, hydroxypropyl acrylate, methyl methacrylate, maleic acid, itaconic acid, vinyl acetate, alkyl vinyl ether, acontic acid, citraconic acid, mesoconic acid, fumeric acid and glutaconic acid. In one example, the polysaccharide hybrid polymer includes residue of acrylic acid and maleic acid. In another example, the residue of acrylic acid and maleic acid are present in the polysaccharide hybrid polymer in weight ratios between about 1:5 and about 5:1.

A suitable concentration range of the components in the polysaccharide hybrid polymer include between about 30% and 80% by weight polysaccharide residue and between about 5% and 75% by weight residue of acrylic acid, methacrylic acid or combinations thereof. A particularly suitable concentration range of the components in the polysaccharide hybrid polymer include between about 40% and 70% by weight polysaccharide residue and between about 5% and 50% by weight acrylic acid, methacrylic acid or combinations thereof.

A suitable concentration range of the components in the polysaccharide hybrid polymer when residue of an ethylenically unsaturated monomer is present includes between about 30% and 80% by weight polysaccharide residue, between about 5% and 75% by weight residue of acrylic acid, methacrylic acid or combinations thereof, and between about 5% and 75% by weight residue of ethylenically unsaturated monomers. A particularly suitable concentration range of the components in the polysaccharide hybrid polymer when residue of ethylenically unsaturated monomers are present includes between about 40% and 70% by weight polysaccharide residue, between about 5% and 50% by weight residue of acrylic acid, methacrylic acid or combinations thereof and between about 10% and 50% by weight residue of the ethylenically unsaturated monomer.

The composition also includes phosphonobutane-1,2,4-tricarboxylic acid or salts thereof (PBTC). Suitable commercially available PBTC include Bayhibit S a 2-phosphobutane-1,2,4-tricarboxylic acid tetrasodium salt available from Lanxess, Pittsburgh, Pa. The combination of polysaccharide hybrid polymer and PBTC may effectively control hard water scale accumulation.

In another embodiment the composition is a detergent composition that generally includes an alkali metal hydroxide, water, a polysaccharide hybrid polymer, and 2-phosphonobutane-1,2,4-tricarboxylic acid or salts thereof (PBTC). The detergent composition, for example, may be particularly suitable for removing soil from a substrate, preventing soil redeposition and controlling hard water scale. A suitable concentration range of the components in a concentrated form of the detergent compositions include between about 1% and about 80% by weight alkali metal hydroxide, between about 1% and about 40% by weight of water, between about 0.1% and about 15% by weight of the polysaccharide hybrid polymer, and between about 0.01% and about 10% by weight of PBTC. A particularly suitable concentration range of the components in the detergent compositions include between about 20% and about 70% by weight alkali metal hydroxide, between about 5% and about 30% by weight of water, between about 1% and about 10% by weight of the polysaccharide hybrid polymer, and between about 0.5% and about 10% by weight of PBTC.

Suitable alkali metal hydroxides include but are not limited to: sodium hydroxide, potassium hydroxide, lithium hydroxide, and combinations thereof. The alkali metal hydroxide may be added to the composition in any form known in the art, including as solid beads, dissolved in an aqueous solution, or a combination thereof. Additionally, more than one alkalinity source may be used according to certain embodiments.

The alkali metal hydroxide controls the pH of the resulting solution when water is added to the detergent composition to form a use solution. The pH of the use solution must be maintained in the alkaline range in order to provide sufficient detergency properties. In one embodiment, the pH of the use solution is between approximately 9 and approximately 13. Particularly, the pH of the use solution is between about 10 and about 12. If the pH of the use solution is too high, for example, above 13, the use solution may be too alkaline and attack or damage the surface to be cleaned.

The alkali metal hydroxide may also function as a hydratable salt to form a solid composition. The hydratable salt can be referred to as substantially anhydrous. By substantially anhydrous, it is meant that the component contains less than about 2% by weight water based upon the weight of the hydratable component. The amount of water can be less than about 1% by weight, and can be less than about 0.5% by weight. There is no requirement that the hydratable salt be completely anhydrous.

The detergent composition also includes water of hydration to hydrate the alkali metal hydroxide/hydratable salt. It should be understood that the reference to water includes both water of hydration and free water. The phrase “water of hydration” refers to water which is somehow attractively bound to a non-water molecule. An exemplary form of attraction includes hydrogen bonding. The water of hydration also functions to increase the viscosity of the mixture during processing and cooling to prevent separation of the components. The amount of water of hydration in the detergent composition will depend on the alkali metal hydroxide/hydratable salt. In addition to water of hydration, the detergent composition may also have free water which isn't attractively bound to a non-water molecule.

The detergent composition also includes a polysaccharide hybrid polymer and PBTC. As discussed above, the polysaccharide hybrid polymer and PBTC combination may be particularly helpful in controlling hard water scale. A suitable concentration of the of the polysaccharide hybrid polymer and PBTC combination in the detergent compositions is between about 0.5% and about 25% by weight of the detergent composition. A particularly suitable concentration of the polysaccharide hybrid polymer and PBTC combination in the detergent compositions is between about 1% and about 15% by weight of the detergent composition.

The polysaccharide hybrid polymer can be a bio-based and/or biodegradable polymer, which reduces the reliance on natural gas and/or petrochemical feedstocks. Biobased content is the amount of biobased carbon in a material or product and can be expressed as a percent of weight (mass) of the total organic carbon in the product. The biobased content can be determined using ASTM Method D6866, entitled Standard Test Methods for Determining the Biobased Content of Natural Range Materials Using Radiocarbon and Isotrope Ratio Mass Spectrometry Analysis. Biodegradability measures the ability of microorganisms present in the disposal environment to completely consume the biobased carbon product within a reasonable time frame and in a specified environment. In one example, the polysaccharide hybrid polymer can include a polysaccharide and a reduced level of petrochemicals. For example, the detergent composition may include at least about 10 wt % biodegradable content. In another example, the detergent composition may include between about 10 wt % and about 80 wt % biodegradable content by weight.

The detergent compositions of the present invention can be provided in any of a variety of embodiments of detergent compositions. In an embodiment, the detergent composition is substantially free of phosphorous, nitrilotriacetic acid (NTA) and ethylenediaminetetraacetic acid (EDTA). Phosphorus-free means a composition having less than approximately 0.5 wt %, more particularly, less than approximately 0.1 wt %, and even more particularly less than approximately 0.01 wt % phosphorous based on the total weight of the composition. NTA-free means a composition having less than approximately 0.5 wt %, less than approximately 0.1 wt %, and particularly less than approximately 0.01 wt % NTA based on the total weight of the composition. When the composition is NTA-free, it is also compatible with chlorine, which functions as an anti-redeposition and stain-removal agent. When diluted to a use solution, the detergent composition includes phosphorous-containing components, NTA and EDTA concentrations of less than approximately 100 ppm, particularly less than approximately 10 ppm, and more particularly less than approximately 1 ppm.

### Additional Functional Materials

The composition can also include various additional functional components. In some embodiments, the polysaccharide hybrid polymer and PBTC make up a large amount, or even substantially all of the total weight of the detergent composition, for example, in embodiments having few or no additional functional materials disposed therein. In one specific example, the composition consists essentially of the polysaccharide hybrid polymer and PBTC. In these embodiments, the component concentration ranges provided above for the detergent are representative of the ranges of those same components in the detergent composition.

In other embodiments, the alkali metal hydroxide, water, 2-phosphonobutane-1,2,4-tricarboxylic acid or salts thereof, and the polysaccharide hybrid polymer make up a large amount, or even substantially all of the total weight of the composition, for example, in embodiments having few or no additional functional materials disposed therein. In one specific example, the composition consists essentially of the alkali metal hydroxide, water, 2-phosphonobutane-1,2,4-tricarboxylic acid or salts thereof, and the polysaccharide hybrid polymer. In these embodiments, the component concentration ranges provided above for the detergent are representative of the ranges of those same components in the composition.

In alternative embodiments, functional materials are added to provide desired properties and functionalities to the composition. For the purpose of this application, the term “functional materials” includes a material that when dispersed or dissolved in a use and/or concentrate solution, such as an aqueous solution, provides a beneficial property in a particular use. Some particular examples of functional materials are discussed in more detail below, although the particular materials discussed are given by way of example only, and that a broad variety of other functional materials may be used. Moreover, the components discussed above may be multi-functional and may also provide several of the functional benefits discussed below.

### Secondary Alkali Source

The composition can include one or more secondary alkali sources. Examples of suitable secondary alkali sources of the composition include, but are not limited to alkali metal carbonates, alkali metal hydroxides and alkali metal silicates. Exemplary alkali metal carbonates that can be used include, but are not limited to: sodium or potassium carbonate, bicarbonate, sesquicarbonate, and mixtures thereof. Exemplary alkali metal hydroxides that can be used include, but are not limited to: sodium or potassium hydroxide. The alkali metal hydroxide may be added to the composition in any form known in the art, including as solid beads, dissolved in an aqueous solution, or a combination thereof. Examples of alkali metal silicates include, but are not limited to sodium or potassium silicate or polysoilicate, sodium or potassium metasilicate and hydrated sodium or potassium metasilicate or a combination thereof.

### Surfactants

The composition may also include a surfactant. A variety of surfactants can be used in the composition, including, but not limited to: anionic, nonionic, cationic, and zwitterionic surfactants. Exemplary surfactants that can be used are commercially available from a number of sources. For a discussion of surfactants, see Kirk-Othmer, Encyclopedia of Chemical Technology, Third Edition, volume 8, pages 900-912. When the composition includes a surfactant as a cleaning agent, the cleaning agent is provided in an amount effective to provide a desired level of cleaning. The composition, when provided as a concentrate, can include the surfactant cleaning agent in a range of about 0.05% to about 20% by weight, about 0.5% to about 15% by weight, about 1% to about 15% by weight, about 1.5% to about 10% by weight, and about 2% to about 8% by weight. Additional exemplary ranges of surfactant in a concentrate include about 0.5% to about 8% by weight, and about 1% to about 5% by weight.

Examples of anionic surfactants useful in the composition include, but are not limited to: carboxylates such as alkylcarboxylates and polyalkoxycarboxylates, alcohol ethoxylate carboxylates, nonylphenol ethoxylate carboxylates; sulfonates such as alkylsulfonates, alkylbenzenesulfonates, alkylarylsulfonates, sulfonated fatty acid esters; sulfates such as sulfated alcohols, sulfated alcohol ethoxylates, sulfated alkylphenols, alkylsulfates, sulfosuccinates, and alkylether sulfates. Exemplary anionic surfactants include, but are not limited to: sodium alkylarylsulfonate, alpha-olefinsulfonate, and fatty alcohol sulfates.

Examples of nonionic surfactants useful in the composition include, but are not limited to, those having a polyalkylene oxide polymer as a portion of the surfactant molecule. Such nonionic surfactants include, but are not limited to: chlorine-, benzyl-, methyl-, ethyl-, propyl-, butyl- and other like alkyl-capped polyethylene glycol ethers of fatty alcohols; polyalkylene oxide free nonionics such as alkyl polyglycosides; sorbitan and sucrose esters and their ethoxylates; alkoxylated amines such as alkoxylated ethylene diamine; alcohol alkoxylates such as alcohol ethoxylate propoxylates, alcohol propoxylates, alcohol propoxylate ethoxylate propoxylates, alcohol ethoxylate butoxylates; nonylphenol ethoxylate, polyoxyethylene glycol ether; carboxylic acid esters such as glycerol esters, polyoxyethylene esters, ethoxylated and glycol esters of fatty acids; carboxylic amides such as diethanolamine condensates, monoalkanolamine condensates, polyoxyethylene fatty acid amides; and polyalkylene oxide block polymers. An example of a commercially available ethylene oxide/propylene oxide block polymer includes, but is not limited to, PLURONIC®, available from BASF Corporation, Florham Park, N.J. An example of a commercially available silicone surfactant includes, but is not limited to, ABIL® B8852, available from Goldschmidt Chemical Corporation, Hopewell, Va. A particularly suitable surfactant is D500, an ethylene oxide/propylene oxide polymer available from BASF Corporation, Florham Park, N.J.

Examples of cationic surfactants that can be used in the composition include, but are not limited to: amines such as primary, secondary and tertiary monoamines with C₁₈ alkyl or alkenyl chains, ethoxylated alkylamines, alkoxylates of ethylenediamine, imidazoles such as a 1-(2-hydroxyethyl)-2-imidazoline, a 2-alkyl-1-(2-hydroxyethyl)-2-imidazoline, and the like; and quaternary ammonium salts, as for example, alkylquaternary ammonium chloride surfactants such as n-alkyl(C₁₂-C₁₈)dimethylbenzyl ammonium chloride, n-tetradecyldimethylbenzylammonium chloride monohydrate, and a naphthylene-substituted quaternary ammonium chloride such as dimethyl-1-naphthylmethylammonium chloride. The cationic surfactant can be used to provide sanitizing properties.

Examples of zwitterionic surfactants that can be used in the composition include, but are not limited to: betaines, imidazolines, and propionates.

When the composition is intended to be used in an automatic dishwashing or warewashing machine, the surfactants selected, if any surfactant is used, can be those that provide an acceptable level of foaming when used inside a dishwashing or warewashing machine. Compositions for use in automatic dishwashing or warewashing machines are generally considered to be low-foaming compositions. Low foaming surfactants that provide the desired level of detersive activity are advantageous in an environment such as a dishwashing machine where the presence of large amounts of foaming can be problematic. In addition to selecting low foaming surfactants, defoaming agents can also be utilized to reduce the generation of foam. Accordingly, surfactants that are considered low foaming surfactants can be used. In addition, other surfactants can be used in conjunction with a defoaming agent to control the level of foaming.

### Builders or Water Conditioners

The composition can include one or more building agents, also called chelating or sequestering agents (e.g., builders), including, but not limited to: condensed phosphates, alkali metal carbonates, phosphonates, aminocarboxylic acids, and/or polyacrylates. In general, a chelating agent is a molecule capable of coordinating (i.e., binding) the metal ions commonly found in natural water to prevent the metal ions from interfering with the action of the other detersive ingredients of a cleaning composition. Preferable levels of addition for builders that can also be chelating or sequestering agents are between about 0.1% to about 70% by weight, about 1% to about 60% by weight, or about 1.5% to about 50% by weight. If the solid composition is provided as a concentrate, the concentrate can include between approximately 1% to approximately 60% by weight, between approximately 3% to approximately 50% by weight, and between approximately 6% to approximately 45% by weight of the builders. Additional ranges of the builders include between approximately 3% to approximately 20% by weight, between approximately 6% to approximately 15% by weight, between approximately 25% to approximately 50% by weight, and between approximately 35% to approximately 45% by weight.

Examples of condensed phosphates include, but are not limited to: sodium and potassium orthophosphate, sodium and potassium pyrophosphate, sodium tripolyphosphate, and sodium hexametaphosphate. A condensed phosphate may also assist, to a limited extent, in solidification of the composition by fixing the free water present in the composition as water of hydration.

Examples of phosphonates include, but are not limited to: 2-phosphonobutane-1,2,4-tricarboxylic acid (PBTC), 1-hydroxyethane-1,1-diphosphonic acid, CH₂C(OH)[PO(OH)₂]₂; aminotri(methylenephosphonic acid), N[CH₂PO(OH)₂]₃; aminotri(methylenephosphonate), sodium salt (ATMP), N[CH₂PO(ONa)₂]₃; 2-hydroxyethyliminobis(methylenephosphonic acid), HOCH₂CH₂N[CH₂PO(OH)₂]₂; diethylenetriaminepenta(methylenephosphonic acid), (HO)₂POCH₂N[CH₂CH₂N[CH₂PO(OH)₂]₂]₂; diethylenetriaminepenta(methylenephosphonate), sodium salt (DTPMP), C₉ H₍₂₈₋ₓ₎N₃NaₓO₁₅P₅ (x=7); hexamethylenediamine(tetramethylenephosphonate), potassium salt, C₁₀H_{(28-x)N}²KₓO₁₂P⁴ (x=6); bis(hexamethylene)triamine(pentamethylenephosphonic acid), (HO₂)POCH₂N[(CH₂)₂N[CH₂PO(OH)₂]₂]₂; and phosphorus acid, H₃PO₃. A preferred phosphonate combination is ATMP and DTPMP. A neutralized or alkali phosphonate, or a combination of the phosphonate with an alkali source prior to being added into the mixture such that there is little or no heat or gas generated by a neutralization reaction when the phosphonate is added is preferred. In one embodiment, however, the composition is phosphorous-free.

Useful aminocarboxylic acid materials containing little or no NTA include, but are not limited to: N-hydroxyethylaminodiacetic acid, ethylenediaminetetraacetic acid (EDTA), hydroxyethylenediaminetetraacetic acid, diethylenetriaminepentaacetic acid, N-hydroxyethyl-ethylenediaminetriacetic acid (HEDTA), diethylenetriaminepentaacetic acid (DTPA), methylglycinediacetic acid (MGDA), glutamic acid-N,N-diacetic acid (GLDA), ethylenediaminesuccinic acid (EDDS),2-hydroxyethyliminodiacetic acid (HEIDA), iminodisuccinic acid (IDS), 3-hydroxy-2-2′-iminodisuccinic acid (HIDS) and other similar acids or salts thereof having an amino group with a carboxylic acid substituent. In one embodiment, however, the composition is free of aminocarboxylates.

Water conditioning polymers can be used as non-phosphorus containing builders. Exemplary water conditioning polymers include, but are not limited to: polycarboxylates. Exemplary polycarboxylates that can be used as builders and/or water conditioning polymers include, but are not limited to: those having pendant carboxylate (—CO₂⁻) groups such as polyacrylic acid, maleic acid, maleic/olefin polymer, sulfonated polymer or terpolymer, acrylic/maleic polymer, polymethacrylic acid, acrylic acid-methacrylic acid polymers, hydrolyzed polyacrylamide, hydrolyzed polymethacrylamide, hydrolyzed polyamide-methacrylamide polymers, hydrolyzed polyacrylonitrile, hydrolyzed polymethacrylonitrile, and hydrolyzed acrylonitrile-methacrylonitrile polymers. Other suitable water conditioning polymers include starch, sugar or polyols comprising carboxylic acid or ester functional groups. Exemplary carboxylic acids include but are not limited to maleic acid, acrylic, methacrylic and itaconic acid or salts thereof. Exemplary ester functional groups include aryl, cyclic, aromatic and C₁-C₁₀ linear, branched or substituted esters. For a further discussion of chelating agents/sequestrants, see Kirk-Othmer, Encyclopedia of Chemical Technology, Third Edition, volume 5, pages 339-366 and volume 23, pages 319-320, the disclosure of which is incorporated by reference herein. These materials may also be used at substoichiometric levels to function as crystal modifiers

### Hardening Agents

The compositions can also include a hardening agent in addition to, or in the form of, the builder. A hardening agent is a compound or system of compounds, organic or inorganic, which significantly contributes to the uniform solidification of the composition. Preferably, the hardening agents are compatible with the cleaning agent and other active ingredients of the composition and are capable of providing an effective amount of hardness and/or aqueous solubility to the processed composition. The hardening agents should also be capable of forming a homogeneous matrix with the cleaning agent and other ingredients when mixed and solidified to provide a uniform dissolution of the cleaning agent from the composition during use.

The amount of hardening agent included in the composition will vary according to factors including, but not limited to: the type of composition being prepared, the ingredients of the composition, the intended use of the composition, the quantity of dispensing solution applied to the solid composition over time during use, the temperature of the dispensing solution, the hardness of the dispensing solution, the physical size of the composition, the concentration of the other ingredients, and the concentration of the cleaning agent in the composition. It is preferred that the amount of the hardening agent included in the composition is effective to combine with the cleaning agent and other ingredients of the composition to form a homogeneous mixture under continuous mixing conditions and a temperature at or below the melting temperature of the hardening agent.

It is also preferred that the hardening agent form a matrix with the cleaning agent and other ingredients which will harden to a solid form under ambient temperatures of approximately 30° C. to approximately 50° C., particularly approximately 35° C. to approximately 45° C., after mixing ceases and the mixture is dispensed from the mixing system, within approximately 1 minute to approximately 3 hours, particularly approximately 2 minutes to approximately 2 hours, and particularly approximately 5 minutes to approximately 1 hour. A minimal amount of heat from an external source may be applied to the mixture to facilitate processing of the mixture. It is preferred that the amount of the hardening agent included in the composition is effective to provide a desired hardness and desired rate of controlled solubility of the processed composition when placed in an aqueous medium to achieve a desired rate of dispensing the cleaning agent from the solidified composition during use.

The hardening agent may be an organic or an inorganic hardening agent. A preferred organic hardening agent is a polyethylene glycol (PEG) compound. The solidification rate of compositions comprising a polyethylene glycol hardening agent will vary, at least in part, according to the amount and the molecular weight of the polyethylene glycol added to the composition. Examples of suitable polyethylene glycols include, but are not limited to: solid polyethylene glycols of the general formula H(OCH₂CH₂)ₙOH, where n is greater than 15, particularly approximately 30 to approximately 1700. Typically, the polyethylene glycol is a solid in the form of a free-flowing powder or flakes, having a molecular weight of approximately 1,000 to approximately 100,000, particularly having a molecular weight of at least approximately 1,450 to approximately 20,000, more particularly between approximately 1,450 to approximately 8,000. The polyethylene glycol is present at a concentration of from approximately 1% to 75% by weight and particularly approximately 3% to approximately 15% by weight. Suitable polyethylene glycol compounds include, but are not limited to: PEG 4000, PEG 1450, and PEG 8000 among others, with PEG 4000 and PEG 8000 being most preferred. An example of a commercially available solid polyethylene glycol includes, but is not limited to: CARBOWAX, available from Union Carbide Corporation, Houston, Tex.

Preferred inorganic hardening agents are hydratable inorganic salts, including, but not limited to: sulfates and bicarbonates. The inorganic hardening agents are present at concentrations of up to approximately 50% by weight, particularly approximately 5% to approximately 25% by weight, and more particularly approximately 5% to approximately 15% by weight. In one embodiment, however, the solid composition if free of sulfates and carbonates including soda ash.

Urea particles can also be employed as hardeners in the compositions. The solidification rate of the compositions will vary, at least in part, to factors including, but not limited to: the amount, the particle size, and the shape of the urea added to the composition. For example, a particulate form of urea can be combined with a cleaning agent and other ingredients, and preferably a minor but effective amount of water. The amount and particle size of the urea is effective to combine with the cleaning agent and other ingredients to form a homogeneous mixture without the application of heat from an external source to melt the urea and other ingredients to a molten stage. It is preferred that the amount of urea included in the composition is effective to provide a desired hardness and desired rate of solubility of the composition when placed in an aqueous medium to achieve a desired rate of dispensing the cleaning agent from the solidified composition during use. In some embodiments, the composition includes between approximately 5% to approximately 90% by weight urea, particularly between approximately 8% and approximately 40% by weight urea, and more particularly between approximately 10% and approximately 30% by weight urea.

The urea may be in the form of prilled beads or powder. Prilled urea is generally available from commercial sources as a mixture of particle sizes ranging from about 8-15 U.S. mesh, as for example, from Arcadian Sohio Company, Nitrogen Chemicals Division. A prilled form of urea is preferably milled to reduce the particle size to about 50 U.S. mesh to about 125 U.S. mesh, particularly about 75-100 U.S. mesh, preferably using a wet mill such as a single or twin-screw extruder, a Teledyne mixer, a Ross emulsifier, and the like.

### Bleaching Agents

Bleaching agents suitable for use in the composition for lightening or whitening a substrate include bleaching compounds capable of liberating an active halogen species, such as Cl₂, Br₂, —OCl⁻ and/or —OBr⁻, under conditions typically encountered during the cleansing process. Suitable bleaching agents for use in the compositions include, but are not limited to: chlorine-containing compounds such as chlorine, hypochlorites, or chloramines. Exemplary halogen-releasing compounds include, but are not limited to: the alkali metal dichloroisocyanurates, chlorinated trisodium phosphate, the alkali metal hypochlorites, monochloramine, and dichloramine. Encapsulated chlorine sources may also be used to enhance the stability of the chlorine source in the composition (see, for example, U.S. Pat. Nos. 4,618,914 and 4,830,773, the disclosure of which is incorporated by reference herein). A bleaching agent may also be a peroxygen or active oxygen source such as hydrogen peroxide, perborates, sodium carbonate peroxyhydrate, potassium permonosulfate, and sodium perborate mono and tetrahydrate, with and without activators such as tetraacetylethylene diamine. When the concentrate includes a bleaching agent, it can be included in an amount between approximately 0.1% and approximately 60% by weight, between approximately 1% and approximately 20% by weight, between approximately 3% and approximately 8% by weight, and between approximately 3% and approximately 6% by weight.

### Fillers

The composition can include an effective amount of detergent fillers which do not perform as a cleaning agent per se, but cooperates with the cleaning agent to enhance the overall cleaning capacity of the composition. Examples of detergent fillers suitable for use in the present cleaning compositions include, but are not limited to: sodium sulfate and sodium chloride. When the concentrate includes a detergent filler, it can be included in an amount up to approximately 50% by weight, between approximately 1% and approximately 30% by weight, or between approximately 1.5% and approximately 25% by weight.

### Defoaming Agents

A defoaming agent for reducing the stability of foam may also be included in the composition. Examples of defoaming agents include, but are not limited to: ethylene oxide/propylene block polymers such as those available under the name Pluronic® N-3 available from BASF Corporation, Florham Park, N.J.; silicone compounds such as silica dispersed in polydimethylsiloxane, polydimethylsiloxane, and functionalized polydimethylsiloxane such as those available under the name Abil® B9952 available from Goldschmidt Chemical Corporation, Hopewell, Va.; fatty amides, hydrocarbon waxes, fatty acids, fatty esters, fatty alcohols, fatty acid soaps, ethoxylates, mineral oils, polyethylene glycol esters, and alkyl phosphate esters such as monostearyl phosphate. A discussion of defoaming agents may be found, for example, in U.S. Pat. No. 3,048,548 to Martin et al., U.S. Pat. No. 3,334,147 to Brunelle et al., and U.S. Pat. No. 3,442,242 to Rue et al., the disclosures of which are incorporated herein by reference. When the concentrate includes a defoaming agent, the defoaming agent can be provided in an amount between approximately 0.0001% and approximately 10% by weight, between approximately 0.001% and approximately 5% by weight, or between approximately 0.01% and approximately 1.0% by weight.

### Anti-Redeposition Agents

The composition can include an anti-redeposition agent for facilitating sustained suspension of soils in a cleaning solution and preventing the removed soils from being redeposited onto the substrate being cleaned. Examples of suitable anti-redeposition agents include, but are not limited to: polyacrylates, styrene maleic anhydride polymers, cellulosic derivatives such as hydroxyethyl cellulose, hydroxypropyl cellulose and carboxymethyl cellulose. When the concentrate includes an anti-redeposition agent, the anti-redeposition agent can be included in an amount between approximately 0.5% and approximately 10% by weight, and between approximately 1% and approximately 5% by weight.

### Stabilizing Agents

The composition may also include stabilizing agents. Examples of suitable stabilizing agents include, but are not limited to: borate, calcium/magnesium ions, propylene glycol, and mixtures thereof. The concentrate need not include a stabilizing agent, but when the concentrate includes a stabilizing agent, it can be included in an amount that provides the desired level of stability of the concentrate. Exemplary ranges of the stabilizing agent include up to approximately 20% by weight, between approximately 0.5% and approximately 15% by weight, and between approximately 2% and approximately 10% by weight.

### Dispersants

The composition may also include dispersants. Examples of suitable dispersants that can be used in the composition include, but are not limited to: maleic acid/olefin polymers, polyacrylic acid, and mixtures thereof. The concentrate need not include a dispersant, but when a dispersant is included it can be included in an amount that provides the desired dispersant properties. Exemplary ranges of the dispersant in the concentrate can be up to approximately 20% by weight, between approximately 0.5% and approximately 15% by weight, and between approximately 2% and approximately 9% by weight.

### Enzymes

Enzymes that can be included in the composition include those enzymes that aid in the removal of starch and/or protein stains. Exemplary types of enzymes include, but are not limited to: proteases, alpha-amylases, and mixtures thereof. Exemplary proteases that can be used include, but are not limited to: those derived from Bacillus licheniformix, Bacillus lenus, Bacillus alcalophilus, and Bacillus amyloliquefacins. Exemplary alpha-amylases include Bacillus subtilis, Bacillus amyloliquefaceins and Bacillus licheniformis. The concentrate need not include an enzyme, but when the concentrate includes an enzyme, it can be included in an amount that provides the desired enzymatic activity when the composition is provided as a use composition. Exemplary ranges of the enzyme in the concentrate include up to approximately 15% by weight, between approximately 0.5% to approximately 10% by weight, and between approximately 1% to approximately 5% by weight.

### Fragrances and Dyes

Various dyes, odorants including perfumes, and other aesthetic enhancing agents can also be included in the composition. Suitable dyes that may be included to alter the appearance of the composition, include, but are not limited to: Direct Blue 86, available from Mac Dye-Chem Industries, Ahmedabad, India; Fastusol Blue, available from Mobay Chemical Corporation, Pittsburgh, Pa.; Acid Orange 7, available from American Cyanamid Company, Wayne, N.J.; Basic Violet 10 and Sandolan Blue/Acid Blue 182, available from Sandoz, Princeton, N.J.; Acid Yellow 23, available from Chemos GmbH, Regenstauf, Germany; Acid Yellow 17, available from Sigma Chemical, St. Louis, Mo.; Sap Green and Metanil Yellow, available from Keyston Analine and Chemical, Chicago, Ill.; Acid Blue 9, available from Emerald Hilton Davis, LLC, Cincinnati, Ohio; Hisol Fast Red and Fluorescein, available from Capitol Color and Chemical Company, Newark, N.J.; and Acid Green 25, Ciba Specialty Chemicals Corporation, Greenboro, N.C.

Fragrances or perfumes that may be included in the compositions include, but are not limited to: terpenoids such as citronellol, aldehydes such as amyl cinnamaldehyde, a jasmine such as C1S-jasmine or jasmal, and vanillin.

### Thickeners

The compositions can include a rheology modifier or a thickener. The rheology modifier may provide the following functions: increasing the viscosity of the compositions; increasing the particle size of liquid use compositions when dispensed through a spray nozzle; providing the use compositions with vertical cling to surfaces; providing particle suspension within the use compositions; or reducing the evaporation rate of the use compositions.

The rheology modifier may provide a use composition that is pseudo plastic, in other words the use composition or material when left undisturbed (in a shear mode), retains a high viscosity. However, when sheared, the viscosity of the material is substantially but reversibly reduced. After the shear action is removed, the viscosity returns. These properties permit the application of the material through a spray head. When sprayed through a nozzle, the material undergoes shear as it is drawn up a feed tube into a spray head under the influence of pressure and is sheared by the action of a pump in a pump action sprayer. In either case, the viscosity can drop to a point such that substantial quantities of the material can be applied using the spray devices used to apply the material to a soiled surface. However, once the material comes to rest on a soiled surface, the materials can regain high viscosity to ensure that the material remains in place on the soil. Preferably, the material can be applied to a surface resulting in a substantial coating of the material that provides the cleaning components in sufficient concentration to result in lifting and removal of the hardened or baked-on soil. While in contact with the soil on vertical or inclined surfaces, the thickeners in conjunction with the other components of the cleaner minimize dripping, sagging, slumping or other movement of the material under the effects of gravity. The material should be formulated such that the viscosity of the material is adequate to maintain contact between substantial quantities of the film of the material with the soil for at least a minute, particularly five minutes or more.

Examples of suitable thickeners or rheology modifiers are polymeric thickeners including, but not limited to: polymers or natural polymers or gums derived from plant or animal sources. Such materials may be polysaccharides such as large polysaccharide molecules having substantial thickening capacity. Thickeners or rheology modifiers also include clays.

A substantially soluble polymeric thickener can be used to provide increased viscosity or increased conductivity to the use compositions. Examples of polymeric thickeners for the aqueous compositions of the invention include, but are not limited to: carboxylated vinyl polymers such as polyacrylic acids and sodium salts thereof, ethoxylated cellulose, polyacrylamide thickeners, cross-linked, xanthan compositions, sodium alginate and algin products, hydroxypropyl cellulose, hydroxyethyl cellulose, and other similar aqueous thickeners that have some substantial proportion of water solubility. Examples of suitable commercially available thickeners include, but are not limited to: Acusol, available from Rohm & Haas Company, Philadelphia, Pa.; and Carbopol, available from B.F. Goodrich, Charlotte, N.C.

Examples of suitable polymeric thickeners include, but not limited to: polysaccharides. An example of a suitable commercially available polysaccharide includes, but is not limited to, Diutan, available from Kelco Division of Merck, San Diego, Calif. Thickeners for use in the compositions further include polyvinyl alcohol thickeners, such as, fully hydrolyzed (greater than 98.5 mol acetate replaced with the —OH function).

An example of a particularly suitable polysaccharide includes, but is not limited to, xanthans. Such xanthan polymers are preferred due to their high water solubility, and great thickening power. Xanthan is an extracellular polysaccharide of xanthomonas campestras. Xanthan may be made by fermentation based on corn sugar or other corn sweetener by-products. Xanthan comprises a poly beta-(1-4)-D-Glucopyranosyl backbone chain, similar to that found in cellulose. Aqueous dispersions of xanthan gum and its derivatives exhibit novel and remarkable rheological properties. Low concentrations of the gum have relatively high viscosities which permit it to be used economically. Xanthan gum solutions exhibit high pseudo plasticity, i.e. over a wide range of concentrations, rapid shear thinning occurs that is generally understood to be instantaneously reversible. Non-sheared materials have viscosities that appear to be independent of the pH and independent of temperature over wide ranges. Preferred xanthan materials include crosslinked xanthan materials. Xanthan polymers can be crosslinked with a variety of known covalent reacting crosslinking agents reactive with the hydroxyl functionality of large polysaccharide molecules and can also be crosslinked using divalent, trivalent or polyvalent metal ions. Such crosslinked xanthan gels are disclosed in U.S. Pat. No. 4,782,901, which is herein incorporated by reference. Suitable crosslinking agents for xanthan materials include, but are not limited to: metal cations such as Al+3, Fe+3, Sb+3, Zr+4 and other transition metals. Examples of suitable commercially available xanthans include, but are not limited to: KELTROL®, KELZAN® AR, KELZAN® D35, KELZAN® S, KELZAN® XZ, available from Kelco Division of Merck, San Diego, Calif. Known organic crosslinking agents can also be used. A preferred crosslinked xanthan is KELZAN® AR, which provides a pseudo plastic use composition that can produce large particle size mist or aerosol when sprayed.

### Methods of Manufacture

In general, the composition of the present invention can be created by combining the 2-phosphonobutane-1,2,4-tricarboxylic acid, the polysaccharide hybrid polymer and any additional functional components and allowing the components to interact.

In one example, the alkali metal hydroxide, water, 2-phosphonobutane-1,2,4-tricarboxylic acid, the polysaccharide hybrid polymer and any additional functional components interact and harden into solid form. The solidification process may last from a few minutes to about six hours, depending on factors including, but not limited to: the size of the formed or cast composition, the ingredients of the composition, and the temperature of the composition.

The solid compositions may be formed using a batch or continuous mixing system. In an exemplary embodiment, a single- or twin-screw extruder is used to combine and mix one or more cleaning agents at high shear to form a homogeneous mixture. In some embodiments, the processing temperature is at or below the melting temperature of the components. The processed mixture may be dispensed from the mixer by forming, casting or other suitable means, whereupon the composition hardens to a solid form. The structure of the matrix may be characterized according to its hardness, melting point, material distribution, crystal structure, and other like properties according to known methods in the art. Generally, a solid composition processed according to the method of the invention is substantially homogeneous with regard to the distribution of ingredients throughout its mass and is dimensionally stable.

In an extrusion process, the liquid and solid components are introduced into final mixing system and are continuously mixed until the components form a substantially homogeneous semi-solid mixture in which the components are distributed throughout its mass. The mixture is then discharged from the mixing system into, or through, a die or other shaping means. The product is then packaged. In an exemplary embodiment, the formed composition begins to harden to a solid form in between approximately 1 minute and approximately 3 hours. Particularly, the formed composition begins to harden to a solid form in between approximately 1 minute and approximately 2 hours. More particularly, the formed composition begins to harden to a solid form in between approximately 1 minute and approximately 20 minutes.

In a casting process, the liquid and solid components are introduced into the final mixing system and are continuously mixed until the components form a substantially homogeneous liquid mixture in which the components are distributed throughout its mass. In an exemplary embodiment, the components are mixed in the mixing system for at least approximately 60 seconds. Once the mixing is complete, the product is transferred to a packaging container where solidification takes place. In an exemplary embodiment, the cast composition begins to harden to a solid form in between approximately 1 minute and approximately 3 hours. Particularly, the cast composition begins to harden to a solid form in between approximately 1 minute and approximately 2 hours. More particularly, the cast composition begins to harden to a solid form in between approximately 1 minute and approximately 20 minutes.

By the term “solid”, it is meant that the hardened composition will not flow and will substantially retain its shape under moderate stress or pressure or mere gravity. The degree of hardness of the solid cast composition may range from that of a fused solid product which is relatively dense and hard, for example, like concrete, to a consistency characterized as being a hardened paste. In addition, the term “solid” refers to the state of the composition under the expected conditions of storage and use of the solid composition. In general, it is expected that the composition will remain in solid form when exposed to temperatures of up to approximately 100° F. and particularly up to approximately 120° F.

The resulting solid composition may take forms including, but not limited to: a cast solid product; an extruded, molded or formed solid pellet, block, tablet, powder, granule, flake; or the formed solid can thereafter be ground or formed into a powder, granule, or flake. In an exemplary embodiment, extruded pellet materials formed by the solidification matrix have a weight of between approximately 50 grams and approximately 250 grams, extruded solids formed by the composition have a weight of approximately 100 grams or greater, and solid block detergents formed by the composition have a mass of between approximately 1 and approximately 10 kilograms. The solid compositions provide for a stabilized source of functional materials. In some embodiments, the solid composition may be dissolved, for example, in an aqueous or other medium, to create a concentrated and/or use composition. The solution may be directed to a storage reservoir for later use and/or dilution, or may be applied directly to a point of use.

In certain embodiments, the solid composition is provided in the form of a unit dose. A unit dose refers to a solid composition unit sized so that the entire unit is used during a single washing cycle. When the solid composition is provided as a unit dose, it is typically provided as a cast solid, an extruded pellet, or a tablet having a size of between approximately 1 gram and approximately 50 grams.

In other embodiments, the solid composition is provided in the form of a multiple-use solid, such as a block or a plurality of pellets, and can be repeatedly used to generate aqueous compositions for multiple washing cycles. In certain embodiments, the solid composition is provided as a cast solid, an extruded block, or a tablet having a mass of between approximately 5 grams and approximately 10 kilograms. In certain embodiments, a multiple-use form of the solid composition has a mass between approximately 1 kilogram and approximately 10 kilograms. In further embodiments, a multiple-use form of the solid composition has a mass of between approximately 5 kilograms and about approximately 8 kilograms. In other embodiments, a multiple-use form of the solid composition has a mass of between about approximately 5 grams and approximately 1 kilogram, or between approximately 5 grams and approximately 500 grams.

Although the composition is discussed as being formed into a solid product, the composition may also be provided in the form of a paste or liquid. When the concentrate is provided in the form of a paste, enough water is added to the composition such that complete solidification of the composition is precluded. In addition, dispersants and other components may be incorporated into the composition in order to maintain a desired distribution of components.

### Methods of Use

The compositions can include concentrate compositions which may be added to an aqueous system or may be diluted to form use compositions. In general, a concentrate refers to a composition that is intended to be added to or diluted with water, and the composition that contacts articles to be washed can be referred to as the use composition.

A use composition may be prepared from the concentrate by diluting the concentrate with water at a dilution ratio that provides a use composition having desired detersive properties. The water that is used to dilute the concentrate to form the use composition can be referred to as water of dilution or a dilutent, and can vary from one location to another. The use composition can also include additional functional ingredients at a level suitable for cleaning, rinsing, or the like.

The concentrate compositions may essentially include only the polysaccharide polymer and PBTC, and additional components and/or functional materials may be added as separate ingredients prior to the point of use or at the point of use. Alternatively, the concentrate compositions may include the polysaccharide polymer and PBTC as well as additional components such as, but not limited to, at least one alkali metal hydroxide.

The typical dilution factor is between approximately 1 and approximately 10,000 but will depend on factors including water hardness, the amount of soil to be removed and the like. In one embodiment, the concentrate is diluted at a ratio of between about 1:10 and about 1:1000 concentrate to water. Particularly, the concentrate is diluted at a ratio of between about 1:100 and about 1:5000 concentrate to water. More particularly, the concentrate is diluted at a ratio of between about 1:250 and 1:2000 concentrate to water.

A suitable concentration range of the components includes between about 1 and about 500 parts-per-million (ppm) of the polysaccharide hybrid polymer and between about 0.1 and 200 ppm of PBTC. A particularly suitable concentration range of the components includes between about 5 and about 500 parts-per-million (ppm) of the polysaccharide hybrid polymer and between about 0.5 and 200 ppm of PBTC. Another particularly suitable concentration range of the components includes between about 10 and 100 ppm of the polysaccharide hybrid polymer and between about 1 and 150 ppm PBTC.

When an alkali metal hydroxide is present, a suitable concentration range of the components in the use composition includes between about 1 and 1000 ppm alkali metal hydroxide, between about 0.1 and 200 ppm PBTC, and between about 1 and 500 ppm of the polysaccharide hybrid polymer. A particularly suitable concentration range of the components in the use composition includes between about 50 and 1000 ppm alkali metal hydroxide, between about 0.5 and 200 ppm PBTC, and between about 5 and 500 ppm of the polysaccharide hybrid polymer. Another particularly suitable concentration range of the components in the use composition includes between about 200 and 800 ppm alkali metal hydroxide, between about 1 and 150 ppm of PBTC, and between about 10 and 100 ppm of the polysaccharide hybrid polymer.

The composition can contain an effective concentration of the alkali metal hydroxide so that use composition has a pH of at least about 9. In one embodiment, the composition is a use composition that can be brought into contact to clean articles or substrates, such as glass, plastic, ceramic, and metal, and the polysaccharide hybrid polymer and PBTC may function to prevent or remove re-deposition of protein on the substrate.

### Examples

The present invention is more particularly described in the following examples that are intended as illustrations only, since numerous modifications and variations within the scope of the present invention will be apparent to those of skill in the art. Unless otherwise noted, all parts, percentages, and ratios reported in the following examples are on a weight bases, and all reagents used in the examples were obtained, or are available, from the chemical suppliers described below, or may be synthesized by conventional techniques.

### Materials Used

Lime-A-Way: a hard water stain remover that eliminates lime, calcium and rust stains and is available from Reckitt Benckiser Ecolab, Inc., St. Paul, Minn.

Guardian Plus®: a warewashing detergent available from Ecolab, Inc., St. Paul, Minn.

Pluronic® N-3: a ethylene oxide/propylene oxide block polymer surfactant available from BASF Corporation

Bayhibit® S: 2-phosphobutane-1,2,4-tricarboxylic acid tetrasodium salt available from Lanxess, Pittsburgh, Pa.

EXP5240: a polysaccharide hybrid polymer containing about 50% by weight polysaccharide reside and about 50% by weight residue of acrylic and maleic acid monomers in a ratio of 2:1.

EXP5853: a polysaccharide hybrid polymer containing about 55% by weight polysaccharide residue and about 45% by weight acrylic acid residue.

Solid Power XL®: a solid detergent containing sodium hydroxide available from Ecolab, St. Paul, Minn.

### Cleaning Libby Glasses

Six 10 oz. Libby glasses were prepared for laboratory warewashing procedures by removing all film and foreign material from the glass surface. A three-gallon stainless steel pail was filled with distilled water and placed on a hot plate set on high. The pail was covered with aluminum foil and brought to boil.

While the water in the pail was brought to a boil, the Libby glasses were placed on a glass rack and loaded in a Hobart AM-15 warewash machine. The warewash machine had a washbath volume of 60 L, a rinse volume of 4.5 L, a wash time of 50 seconds and a rinse time of 9 seconds. The warewash machine was filled with hot soft water (130° F. minimum) and 20 grams of Lime-A-Way, the door was closed and the automatic cycle was run.

When the cycle was complete, the warewash machine was drained, refilled with hot soft water and 20 grams of Guardian Plus, and the automatic cycle was run. When the cycle was complete, the warewash machine was drained, refilled with hot soft water and 10 grams of sodium tripolyphosphate, and the automatic cycle was run again.

After completion of the automatic cycle with polyphosphate, the machine was drained and refilled with the boiling distilled water from the pail. The control panel was switched to a delime setting and the machine was allowed to run with the distilled water for three minutes. After three minutes, the glasses were removed and the tops of the glasses were mopped with a clean, dry towel. The glasses were allowed to dry in the glass rack. The rack may be elevated on one side to facilitate draining and drying.

100 Cycle Warewashing Test

To determine the ability of various detergent compositions to remove spots and film from ware, six Libby 10 oz. glass tumblers were prepared by removing all film and foreign material from the surfaces of the glasses as described above. A Hobart AM-15 warewash machine was then filled with an appropriate amount of water and the water was tested for hardness. After recording the hardness value, the tank heaters were turned on. On the day of the experiments, the water hardness was 17 grains (1 grain=17 parts-per-million). The warewash machine was turned on and wash/rinse cycles were run through the machine until a wash temperature of between about 150° F. and about 160° F. and a rinse temperature of between about 175° F. and about 190° F. were reached. The controller was then set to dispense an appropriate amount of detergent into the wash tank. The detergent was dispensed such that when the detergent was mixed with water during the cycle to form a use solution, the detergent concentration in the use solution is specified in Table 1. The solution in the wash tank was titrated to verify detergent concentration. The warewash machine had a washbath volume of 53 liters, a rinse volume of 2.8 liters, a washtime of 50 seconds, and a rinse time of 9 seconds.

The six clean glass tumblers were placed diagonally in a Raburn rack and one Newport 10 oz. plastic tumbler was placed off-diagonally in the Raburn rack (see figure below for arrangement) and the rack was placed inside the warewash machine. (P=plastic tumbler; G=glass tumbler).

| | | | | | |
|---|---|---|---|---|---|
| | | | | | G |
| | | | | G | |
| | | | G | | |
| | | G | | | |
| | G | | | P | |
| G | | | | | |

The 100 cycle test was then started. At the beginning of each wash cycle, the appropriate amount of detergent was automatically dispensed into the warewash machine to maintain the initial detergent concentration. The detergent concentration was controlled by conductivity.

Upon completion of 100 cycles, the rack was removed from the warewash machine and the glass and plastic tumblers were allowed to dry. The glass and plastic tumblers were then graded for spot and film accumulation using an analytical light box evaluation. The light box test used a digital camera, a light box, a light source, a light meter and a control computer employing “Spot Advance” and “Image Pro Plus” commercial software. A glass to be evaluated was placed on its side on the light box, and the intensity of the light source was adjusted to a predetermined value using the light meter. A photographic image of the glass was taken and saved to the computer. The software was then used to analyze the upper half of the glass, and the computer displayed a histogram graph with the area under the graph being proportional to the thickness of the film.

Generally, a lower light box score indicates that more light was able to pass through the tumbler. Thus, the lower the light box score, the more effective the composition was at preventing scale on the surface of the tumbler.

### Samples 1-7 and Comparative Samples A and B

Samples 1-7 included varying concentrations of Bayhibit S (phosphonate) and EXP5853 or EXP5240 (polysccharide hybrid polymers). The active water conditioner package (active we package) was the same for each Sample. Comparison Sample A was a Solid Power XL available from Ecolab Inc., St. Paul. Comparison Sample B was similar to the Samples 1-7 but did not include Bayhibit, EXP5853 or EXP5240. The component concentrations of the detergent compositions of Samples 1-7 and Comparative Example B are presented below in Table 1.

TABLE 1

| | | | | | | | | Comp. |
|---|---|---|---|---|---|---|---|---|
| | SMP 1 | SMP 2 | SMP 3 | SMP 4 | SMP 5 | SMP 6 | SMP 7 | SMP B |
| Sodium hydroxide | 67.09 | 67.09 | 67.09 | 67.09 | 67.09 | 67.09 | 67.09 | 79.1 |
| Water | 16.07 | 23.92 | 18.73 | 21.33 | 19.43 | 17.13 | 21.68 | 18.9 |
| Pluronic N3 | 1.71 | 1.71 | 1.71 | 1.71 | 1.71 | 1.71 | 1.71 | 2 |
| EXP5853, 40.9% | 15.13 | 0 | 10 | 5 | 0 | 0 | 0 | 0 |
| EXP5240, 44% | 0 | 0 | 0 | 0 | 9.3 | 14.07 | 4.65 | 0 |
| Bayhibit S, 85% | 0 | 7.28 | 2.47 | 4.87 | 2.47 | 0 | 4.87 | 0 |
| Total | 100 | 100 | 100 | 100 | 100 | 100 | 100 | 100 |
| Active wc package | 6.19 | 6.19 | 6.19 | 6.18 | 6.19 | 6.19 | 6.19 | 0 |
| Use concentration | 750 | 750 | 750 | 750 | 750 | 750 | 750 | 636 |
| (ppm) | | | | | | | | |

Table 2 presents the total light box score for the glass tumblers, plastic tumblers, and all tumblers (SUM(glass), SUM(plastic), SUM(total), respectively). The average glass tumbler light box score is also provided (Average(glass)).

TABLE 2

| | SUM | SUM | SUM | Average |
|---|---|---|---|---|
| | (glass) | (plastic) | (total) | (glass) |
| SMP 1 | 348135 | 28111 | 376246 | 58023 |
| SMP 2 | 202015 | 22680 | 224695 | 33669 |
| SMP 3 | 152432 | 18756 | 171188 | 25405 |
| SMP 4 | 154080 | 21004 | 175084 | 25680 |
| SMP 5 | 126298 | 20685 | 146983 | 21050 |
| SMP 6 | 252540 | 30146 | 282686 | 42090 |
| SMP 7 | 118164 | 20192 | 138356 | 19694 |
| Comp SMP A | 147284 | 30191 | 177475 | 24547 |
| Comp SMP B | 393210 | 65535 | 458745 | 65535 |

The polysaccharide hybrid polymer and PBTC combination improved the light box scores compared to Comparative Samples B which did not include the polysaccharide hybrid polymer and PBTC. A percentage difference is calculated by dividing the difference of two values by the average of two values. The percentage differences of the total light box score after 100 cycles using a polysaccharide hybrid polymer and PBTC compared to Comparative Sample B (which did not include a polysaccharide hybrid polymer and PBTC) were 91% for Sample 3, 90% for Sample 4, 103% for Sample 5, and 107% for Sample 7.

The polysaccharide hybrid polymer and PBTC combination also showed improvements over the use of the polysaccharide hybrid polymer alone. For polysaccharide hybrid polymer EXP 5853, the percentage difference of the total light box score after 100 cycles of Sample 3 compared to Sample 1 was 68% and the difference between Sample 4 and Sample 1 was 75%. Similarly, for polysaccharide hybrid polymer EXP 5240, the difference between Samples 5 and 6 was 63% and the difference between Samples 7 and 6 was 69%.

Further, as shown in Table 2, Samples 3, 4, 5 and 7, which included Bayhibit S and polysaccharide hybrid polymer, were as effective as or more effective than the solid detergent containing sodium hydroxide of Comparative Sample A in removing and/or preventing hard water scale.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the above described features.

The following is claimed:

1. A cleaning composition comprising:
at least one alkali metal hydroxide;
water;
2-phosphonobutane-1,2,4-tricarboxylic acid or salts thereof; and
a polysaccharide hybrid polymer comprising:
polysaccharide residue in an amount between approximately 30% and approximately 80% by weight of the polysaccharide hybrid polymer; and
residue of at least one of acrylic acid, methacrylic acid and combinations thereof present in an amount between approximately 5% and approximately 75% by weight of the polysaccharide hybrid polymer.

2. The cleaning composition of claim 1, wherein the polymer further comprises residue of at least one ethylenically unsaturated monomer present in an amount between approximately 5% and approximately 75% by weight of the polysaccharide hybrid polymer.

3. The cleaning composition of claim 2, wherein the ethylenically unsaturated monomer is selected from the group consisting of methacrylic acid, ethacrylic acid, hydroxypropyl acrylate, methyl methacrylate, maleic acid. itaconic acid, vinyl acetate, alkyl vinyl ether, acontic acid, citraconic acid, mesoconic acid, fumeric acid and glutaconic acid.

4. The cleaning composition of claim 1, wherein the at least one alkali metal hydroxide includes sodium hydroxide, potassium hydroxide, lithium hydroxide or combinations thereof.

5. The cleaning composition of claim 1, wherein the polysaccharide hybrid polymer has a molecular weight between approximately 2,000 g/mol and 25,000 g/mol.

6. The cleaning composition of claim 1, wherein the polysaccharide hybrid polymer is present in an amount between about 0.1% and about 15% by weight of the cleaning composition.

7. The cleaning composition of claim 6, wherein 2-phosphonobutane-1,2,4-tricarboxylic acid or salts thereof are present in an amount between about 0.01% and about 10% by weight of the cleaning composition.

8. The cleaning composition of claim 7, wherein the alkali metal hydroxide is present in an amount between about 1% and about 80% by weight of the cleaning composition.

9. The cleaning composition of claim 1, wherein the 2-phosphonobutane-1,2,4-tricarboxylic acid or salts thereof and the polysaccharide hybrid polymer are present in a combined amount between approximately 0.5% and approximately 25% by weight of the cleaning composition.

10. The cleaning composition of claim 1, wherein the cleaning composition contains at least about 10% biodegradable content by weight.

11. A method of using a composition, the method comprising:
mixing water with a detergent composition to form a use solution, wherein the use solution comprises:
at least one alkali metal hydroxide present in an amount between about 1 ppm and about 1000 ppm;
2-phosphonobutane-1,2,4-tricarboxylic acid or salts thereof present in an amount between about 0.1 ppm and about 200 ppm; and
a polysaccharide hybrid polymer present in an amount between about 1 ppm and about 500 ppm, wherein the polysaccharide hybrid polymer comprises between about 30% and about 80% by weight polysaccharide residue and between about 5% and about 75% by weight residue of acrylic acid, methacrylic acid or combinations thereof.

12. The method of claim 11, wherein the polysaccharide hybrid polymer further comprises:
residue of at least one ethylenically unsaturated monomer present in an amount between about 5% and about 75% by weight of the polysaccharide hybrid polymer.

13. The method of claim 11, wherein the ethylenically unsaturated monomer is selected from the group consisting of methacrylic acid, ethacrylic acid, hydroxypropyl acrylate, methyl methacrylate, maleic acid. itaconic acid, vinyl acetate, alkyl vinyl ether, acontic acid, citraconic acid, mesoconic acid, fumeric acid and glutaconic acid.

14. The method of claim 11, wherein the at least one alkali metal hydroxide includes sodium hydroxide, potassium hydroxide, lithium hydroxide or combinations thereof.

15. The method of claim 11, where the polymer has a molecular weight between approximately 2,000 g/mol and 25,000 g/mol.

16. A method for controlling hard water scale, the method comprising:
adding a polysaccharide hybrid polymer and 2-phosphonobutane-1,2,4-tricarboxylic acid or salts thereof to an aqueous system to control hard water scaling, wherein the polysaccharide hybrid polymer comprises:
residue of a polysaccharide present in an amount between about 30% and about 80% the polysaccharide hybrid polymer; and
residue of acrylic acid, methacrylic acid or combinations thereof present in amount between about 5% and about 75% weight of the polysaccharide hybrid polymer, and
wherein the polysaccharide hybrid polymer and 2-phosphonobutane-1,2,4-tricarboxylic acid or salts thereof are added in amounts such that aqueous system includes 1-500 ppm polysaccharide hybrid polymer and 0.1-200 ppm 2-phosphonobutane-1,2,4-tricarboxylic acid or salts thereof.

17. The method of claim 16, and further comprising:
adding at least one alkali metal hydroxide to the aqueous system to form a use solution.

18. The method of claim 16, wherein the polysaccharide hybrid polymer and the 2-phosphonobutane-1,2,4-tricarboxylic acid or salts thereof are present in a weight ratio between about 15:1 and about 1:15.

19. The method of claim 16, wherein the polysaccharide hybrid polymer further comprises at least one ethylenically unsaturated monomer present in an amount between approximately 5% and approximately 75% by weight of the polymer.

20. The method of claim 19, wherein the ethylenically unsaturated monomer is selected from the group consisting of methacrylic acid, ethacrylic acid, hydroxypropyl acrylate, methyl methacrylate, maleic acid. itaconic acid, vinyl acetate, alkyl vinyl ether, acontic acid, citraconic acid, mesoconic acid, fumeric acid and glutaconic acid.
